(19) United States
(12) Patent Application Publication
(10) Pub. No.: US 2015/0380765 A1
(43) Pub. Date: Dec. 31, 2015

(54) SOLID ELECTROLYTE AND ALL-SOLID STATE ION SECONDARY BATTERY USING THE SAME

(71) Applicant: HITACHI, LTD., Tokyo (JP)

(72) Inventors: Tadashi FUJIEDA, Tokyo (JP); Jun KAWAJI, Tokyo (JP); Takuya AOYAGI, Tokyo (JP); Yusuke ASARI, Tokyo (JP); Takashi NAITO, Tokyo (JP); Hirotsugu TAKIZAWA, Sendai (JP); Yamato HAYAHI, Sendai (JP); Yuya NAKATANI, Sendai (JP)

(73) Assignee: HITACHI, LTD., Tokyo (JP)

(21) Appl. No.: 14/764,776

(22) PCT Filed: Mar. 15, 2013
(86) PCT No.: PCT/JP2013/057344

§ 371 Date: Jul. 30, 2015

(51) Int. Cl. H01M 10/0562; H01M 10/0525

(52) U.S. Cl. CPC H01M 10/0562; H01M 10/0525; H01M 2300/0068

(57) ABSTRACT

To provide both resistance to reduction and high ion conductivity, a solid electrolyte includes a crystal having a structure expressed as A_{4-2x-y-z}BₓSn_{3-y}M_{y}O_{8-z}N_{z} (1≦4−2x−y−z<4, A: Li, Na, B: Mg, Ca, Sr, Ba, M: V, Nb, Ta, N: F, Cl) or has a crystal having a structure expressed as A_{2-1.5x-0.5y-0.5z}BₓSn_{3-y}M_{y}O_{8-z}N_{z} (0.5≦2−1.5x−0.5y−0.5z<2, A: Mg, Ca, B: Sc, Y, Sb, Si, M: V, Nb, Ta, N: F, Cl).

### TECHNICAL FIELD

The present invention relates to a solid electrolyte and an all-solid state ion secondary battery.

### BACKGROUND ART

All-solid state ion secondary batteries in which an incombustible or fire-retardant inorganic solid electrolyte is used can be enhanced in thermal resistance and can be made intrinsically safe. In such all-solid state ion secondary batteries, therefore, module cost can be lowered and energy density can be enhanced. In recent years, sulfide solid electrolytes with high ion conductivity have been developed. The sulfide solid electrolytes, however, would generate toxic or corrosive gas upon reaction with water, and are accompanied with a fear about stability. On the other hand, oxide solid electrolytes are excellent in stability. However, an oxide solid electrolyte material which has resistance to reduction associated with a negative electrode potential and has a high ion conductivity comparable to that of the sulfide solid electrolytes has not yet been developed.

Non-patent Document 1 discloses Na₄Sn₃O₈-based oxide solid electrolytes which is free of reducing elements and has a skeleton structure having a strong covalent bond nature.

### PRIOR ART DOCUMENTS

### Non-Patent Document

Non-patent Document 1: M. Iwasaki, et al.: J. Mater. Chem., 12, 1068 (2002)

### SUMMARY OF THE INVENTION

### Problem to be Solved by the Invention

However, the solid electrolytes disclosed in the above-mentioned non-patent document have a drawback in that there is room for further improvement as to ionic conductivity of the solid electrolytes, and the document discloses nothing about measures to cope with the drawback.

It is an object of the present invention to provide a solid electrolyte which has both resistance to reduction and high ion conductivity, and an all-solid state ion secondary battery in which the solid electrolyte is used.

### Means for Solving the Problem

To achieve the object, a solid electrolyte in accordance with the present invention includes a crystal having a structure expressed as A_{4-2x-y-z}BₓSn_{3-y}M_{y}O_{8-z}N_{z} (1≦4−2x−y−z<4, A: Li, Na, B: Mg, Ca, Sr, Ba, M: V, Nb, Ta, N: F, Cl), or has a crystal having a structure expressed as A_{2-1.5x-0.5y-0.5z}BₓSn_{3-y}M_{y}O_{8-z}N_{z} (0.5≦2−1.5x−0.5y−0.5z<2, A: Mg, Ca, B: Sc, Y, Sb, Bi, M: V, Nb, Ta, N: F, Cl).

### Effect of the Invention

According to the present invention, it is possible to provide a solid electrolyte which has both resistance to reduction and high ion conductivity, and an all-solid state ion secondary battery in which the solid electrolyte is used.

### BRIEF DESCRIPTION OF THE DRAWINGS

FIG. 1 is a diagram showing a crystal structure of a solid electrolyte.

FIG. 2 is a sectional view of a major part of an all-solid state ion secondary battery.

### MODES FOR CARRYING OUT THE INVENTION

A rate limiting factor for the diffusion of A ions in an A₄Sn₃O₈ system (A=Li, Na, Mg, Ca) is electrostatic repulsive forces due to the adjacent A ions. Therefore, it is effective to reduce the atomic weight of A, to introduce vacancies, and to thereby lower the diffusion barrier. A specific example of means for reducing the atomic weight of A, in the case where A is Li or Na, is to substitute part of A with a bivalent cation, and that in the case where A is Mg or Ca is to substitute part of A with a trivalent cation. Or, alternatively, part of Sn may be substituted with a pentavalent cation, or part of O may be substituted with a univalent anion.

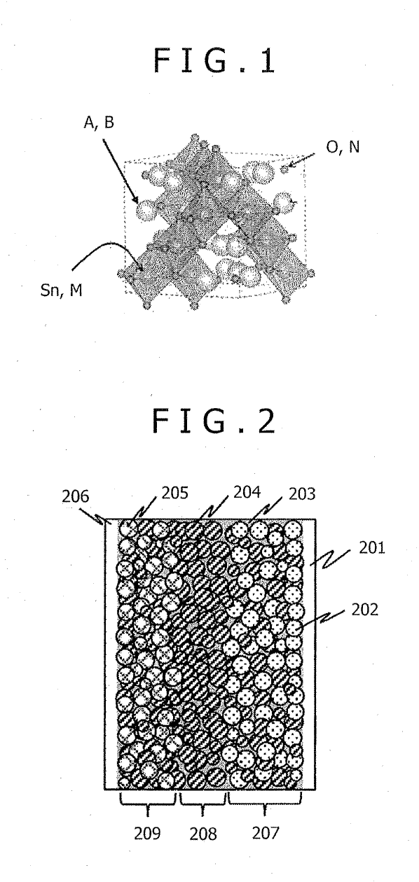

An embodiment of the present invention will be described in detail below, referring to the drawings as required. A solid electrolyte contains a crystal having a structure expressed as A_{4-2x-y-z}BₓSn_{3-y}M_{y}O_{8-z}N_{z} (1≦4−2x−y−z<4, A: Li, Na, B: Mg, Ca, Sr, Ba, M: V, Nb, Ta, N: F, Cl) or A_{2-1.5x-0.5y-0.5z}BₓSn_{3-y}M_{y}O_{8-z}N_{z} (0.5≦2−1.5x−0.5y−0.5z<2, A: Mg, Ca, B: Sc, Y, Sb, Bi, M: V, Nb, Ta, N: F, Cl), as shown in FIG. 1. Here, A is a single component, and is either Li or Na or is either Mg or Ca. In the case where A is Li or Na, the amounts of substituent elements should be in such ranges that 1≦4−2x−y−z<4; if 4−2x−y−z<1, other crystals than the desired would also separate out. In the case where A is Mg or Ca, the amounts of substituent elements should be in such ranges that 0.5≦2−1.5x−0.5y−0.5z<2; if 2−1.5x−0.5y−0.5z<0.5, other crystals than the desired would also separate out.

Besides, by adding to the solid electrolyte powder a vanadium oxide glass which has a low melting point and which softens to be fluid at a low temperature of 500° C. or below, it is possible to easily form a dense sintered body.

FIG. 2 shows a sectional view of a major part of an all-solid state ion secondary battery. A positive electrode active material layer 207 formed on a positive electrode collector 201 and a negative electrode active material layer 209 formed on a negative electrode collector 206 are joined to each other through a solid electrolyte layer 208.

In the positive electrode active material layer 207, positive electrode active material particles 202 and particles 204 of the aforementioned solid electrolyte are bound together by a vanadium oxide glass 203. In the negative electrode active material layer 207, negative electrode active material particles 205 and the aforementioned solid electrolyte particles 204 are bound together by the vanadium oxide glass 203. In other words, in this structure, the active material particles and the solid electrode particles are dispersed in the vanadium oxide glass. While the solid electrolyte particles 204 are bound together by the vanadium oxide glass 203 in the solid electrolyte layer 208, a sintered body of the solid electrolyte particles 204 may be used without using the vanadium oxide glass 203. Note that the positive electrode active material layer and the negative electrode active material layer are perfectly electrically insulated from each other by the solid electrolyte layer.

Besides, a conductive assistant may be added, in order to enhance conductivity in the active material layer of each electrode. However, in view of the fact that crystallization of the vanadium oxide glass as a binder between the active material particles and the solid electrolyte particles enhances the conductivity of the active material layer(s), the conductive assistant can be omitted. Preferable examples of the conductive assistant include carbon materials such as graphite, acetylene black, Ketjen black, etc., powders of metals such as gold, silver, copper, nickel, aluminum, titanium, etc., and conductive oxides such as indium tin oxide (ITO), titanium oxide, tin oxide, zinc oxide, tungsten oxide, etc.

The vanadium oxide glass contains vanadium, and contains at least one of tellurium and phosphorus as vitrifying component. Other than these, iron or tungsten may be added, whereby water resistance can be enhanced remarkably. In addition, in order to prevent a reaction from taking place between the active material particles and the solid electrolyte particles, it is preferable to set the softening point of the vanadium oxide glass to be not higher than 500° C.

The amount of the vanadium oxide glass added based on the amount of the active material or the solid electrolyte, by volume, is desirably not less than 5 vol % and not more than 40 vol %. When the addition amount is not less than 5 vol %, gaps between the active material particles and the solid electrolyte particles can be sufficiently filled up. When the addition amount is not more than 40 vol %, charge/discharge capacity and charge/discharge rate can be prevented from being lowered due to reductions in the amount of the active material and the amount of the solid electrolyte.

In addition, by crystallizing at least part of the vanadium oxide glass in the positive electrode active material layer, it is possible to enhance ion conductivity and electron conductivity.

As the positive electrode active material, there can be used any known positive electrode active material that is capable of occlusion and release of lithium ions. Examples of such positive electrode active material include those based on spinel, olivine, laminar oxide, solid solution, silicate or the like. In addition, the vanadium oxide glass can be used as the positive electrode active material, and by crystallizing at least part of the glass it is possible to enhance ion conductivity and electron conductivity.

As the negative electrode active material, there can be used any known negative electrode active material that is capable of occlusion and release of lithium ions. Examples of such negative electrode active material include carbon materials represented by graphite, alloy materials such as TiSn alloys, TiSi alloys, etc., and oxides such as Li₄Ta₅O₁₂, LiTiO₄, etc. In addition, lithium metal foil may also be used. Besides, vanadium oxide glass can be used as the negative electrode active material, and by crystallizing at least part of the glass it is possible to enhance ion conductivity and electron conductivity.

The present invention will be described specifically below, with reference to Examples.

### EXAMPLE 1

### <Preparation of Lithium Ion Conductive Solid Electrolytes>

Lithium ion conductive solid electrolytes expressed as Li_{4-2x-y-z}BₓSn_{3-y}M_{y}O_{8-z}N_{z} (1≦4−2x−y−z<4, B: Mg, Ca, M: Nb, Ta, N: F) were prepared. Each of mixed powders of raw material compositions (molar ratios) of Nos. 1 to 11 in Table 1 was molded into a pellet shape by cold pressing. Each of the pellets was, in the state of being embedded in a mixed powder of the same composition, calcined in atmospheric air at 1,400° C. for 10 minutes by use of a microwave heater. Note that in the case of ordinary electric-furnace heating it takes a long time to finish calcining, and lithium having a high vapor pressure may be lost by evaporation. In view of this, there was applied microwave heating by which calcining can be finished in a short time.

For pulverized powders of the thus calcined pellets, X-ray diffraction pattern was examined. All the X-ray diffraction patterns resembled the pattern of Li₄Sn₃O₈. Though not set forth in Table 1, however, in the case where 4−2x−y−z<1 in Li_{4-2x-y-z}BₓSn_{3-y}M_{y}O_{8-z}N_{z}, an X-ray diffraction peak or peaks due to a foreign crystal or crystals other than Li₄Sn₃O₈ were observed. For the solid electrolyte, only substitution of Li with B (Mg, Ca) may be made, or only substitution of Sn with M (Nb, Ta) may be made, or only substitution of O with F may be made; in short, it suffices to perform at least one of such substitutions (for example, substitution off Li with B). All the substitutions (substitution of Li with B, substitution of Sn with M, and substitution of O with N) may be made. This applies also to Na, Mg, and Ca which will be described in Examples below.

The calcined pellets were served to measurement of lithium ion conductivity at room temperature by an AC impedance method, the results being set forth in Table 1. As compared with the pellet of No. 1 (Li₄Sn₃O₈) which was free of element substitution, the pellets of Nos. 2 to 11 obtained through element substitution showed enhanced values of ionic conductivity. Besides, there was observed a tendency toward an increase in ionic conductivity with increases in the amounts of B, M, and N elements, namely, the substituent elements.

Furthermore, resistance to reduction of each solid electrolyte was evaluated by measurement of the potential at which a reduction current is generated. The pulverized powder of the calcined pellet, carbon black as a conductive assistant, and polyvinylidene fluoride as a binder were mixed in a volume ratio of 70:10:20, and an appropriate amount of N-methyl-2-pyrrolidone (NMP) was added to the mixture, to prepare a paste. The paste was applied to a 20 μm-thick aluminum foil, and was dried by heating in atmospheric air at 90° C. for 1 hour. Thereafter, the coated foil was pressed, die-cut into a disk having a diameter of 15 mm, and subjected to a heat treatment in vacuum at 120° C. for 1 hour, to produce a solid electrolyte electrode. The solid electrolyte electrode and a Li plate as a counter electrode were stacked, with a 30 μm-thick separator impregnated with a liquid electrolyte being interposed therebetween, and the stack was clamped between two SUS-made jigs. In this condition, a voltage varying from 5 V to 1 V relative to the potential of the Li metal was impressed on the solid electrolyte electrode. In this potential scanning range, generation of a reduction current was not observed, and at least the reduction potential was less than 1 V. Thus, the solid electrolytes were found to be excellent in resistance to reduction. Note that the liquid electrolyte used was a solution prepared by dissolving lithium hexafluorophosphate (LiPF₆), in a concentration of 1 mol/L, in a solvent obtained by mixing ethylene carbonate (EC) and ethyl methyl carbonate (EMC) in a volume ratio of 1:2.

### EXAMPLE 2

### <Preparation of Sodium Ion Conductive Solid Electrolytes>

Sodium ion conductive solid electrolytes expressed as Na_{4-2x-y-z}BₓSn_{3-y}M_{y}O_{8-z}N_{z} (1≦4−2x−y−z<4, B: Mg, Ca, M: Nb, Ta, N: Cl) were prepared. Each of mixed powders of raw material compositions (molar ratios) of Nos. 12 to 23 and Nos. 28 and 29 in Table 1 was molded into a pellet shape by cold pressing. Each of the pellets was, in the state of being embedded in a mixed powder of the same composition, subjected to precalcining in atmospheric air at 800° C. for 4 hours by use of an electric furnace. Each of the precalcined pellets was again pulverized and mixed, and the resulting mixed powder was re-molded into a pellet shape by cold pressing. Each of the thus obtained pellets was, in the state of being embedded in a precalcinined mixed powder of the same composition, subjected to calcining at 1,300° C. for 10 hours by use of an electric furnace.

For pulverized powders of the thus calcinined pellets, X-ray diffraction pattern was examined. All the X-ray diffraction patterns resembled the pattern of Na₄Sn₃O₈. Though not set forth in Table 1, however, in the case where 4−2x−y−z<1 in Na_{4-2x-y-z}BₓSn_{3-y}M_{y}O_{8-z}N_{z}, an X-ray diffraction peak or peaks due to a foreign crystal or crystals other than Na₄Sn₃O₈ were observed.

The calcined pellets were served to measurement of sodium ion conductivity at room temperature by an AC impedance method, the results being set forth in Table 1. As compared with the pellet of No. 12 (Na₄Sn₃O₈) which was free of element substitution, the pellets of Nos. 13 to 23 and Nos. 28 and 29 obtained through element substitution showed enhanced values of ionic conductivity. Besides, there was observed a tendency toward an increase in ionic conductivity with increases in the amounts of B, M, and N elements, namely, the substituent elements.

Note that the sample of No. 23 in Table 1 is a sample obtained by once preparing Na_{3.6}Sn_{2.6}Nb_{0.4}O₈ and then substituting Na ions with Li ions by ion exchange, and, therefore, the ionic conductivity shown in Table 1 in regard of this sample is the value of Li ion conductivity. The method for ion exchange is not particularly limited. In this Example, the ion exchange was conducted by immersing the calcined pellet in a molten salt of lithium nitrate, obtained by melting lithium nitrate by heating to about 300° C., for 30 minutes.

Furthermore, resistance to reduction of each solid electrolyte was evaluated by measuring the potential at which a reduction current is generated, by the same method as in Example 1. For each of the solid electrolytes, it was found that at least the reduction potential is less than 1 V. Thus, each solid electrolyte was confirmed to be excellent in resistance to reduction.

### EXAMPLE 3

### <Preparation of Magnesium Ion Conductive Solid Electrolytes>

Magnesium ion conductive solid electrolytes expressed as Mg_{2-1.5x-0.5y-0.5z}BₓSn_{3-y}M_{y}O₈ (0.5≦2−1.5x−0.5y−0.5z<2, B: Sc, M: Nb) were prepared. Each of mixed powders of raw material compositions (molar ratios) of Nos. 24 and 25 in Table 1 was molded into a pellet shape by cold pressing. Each of the pellets was, in the state of being embedded in a mixed powder of the same composition, subjected to precalcining in atmospheric air at 800° C. for 4 hours by use of an electric furnace. Each of the precalcined pellets was again pulverized and mixed, and the resulting mixed powder was re-molded into a pellet shape by cold pressing. Each of the thus obtained pellets was, in the state of being embedded in a precalcined mixed power of the same composition, subjected to calcining at 1,300° C. for 10 hours by use of an electric furnace.

For pulverized powders of the thus calcined pellets, X-ray diffraction pattern was examined. All the X-ray diffraction patterns resembled the pattern of Mg₂Sn₃O₈. Though not set forth in Table 1, however, in the case where 2−1.5x−0.5y−0.5z<0.5, an X-ray diffraction peak or peaks due to a foreign crystal or crystals other than Mg₂Sn₃O₈ were observed.

The calcined pellets were served to measurement of magnesium ion conductivity at room temperature by an AC impedance method, the results being set forth in Table 1. The calcined pellets were found to have an ionic conductivity of the order of magnitude of 10⁻⁵.

Furthermore, resistance to reduction of each solid electrolyte was evaluated by measuring the potential at which a reduction current is generated, by the same method as in Example 1. For each solid electrolyte, it was found that at least the reduction potential is less than 1 V. Thus, each solid electrolyte was confirmed to be excellent in resistance to reduction.

### EXAMPLE 4

### <Preparation of Calcium Ion Conductive Solid Electrolyte>

Calcium ion conductive solid electrolytes expressed as Ca_{2-1.5x-0.5y-0.5z}BₓSn_{3-y}M_{y}O₈ (0.5≦2−1.5x−0.5y−0.5z<2, B: Bi, M: Ta) were prepared. Each of mixed powders of raw material compositions (molar ratios) of Nos. 26 and 27 in Table 1 was molded into a pellet shape by cold pressing. Each of the pellets was, in the state of being embedded in a mixed powder of the same composition, subjected to precalcining in atmospheric air at 800° C. for 4 hours by use of an electric furnace. Each of the precalcined pellets was again pulverized and mixed, and the resulting mixed powder was re-molded into a pellet shape by cold pressing. Each of the thus obtained pellets was, in the state of being embedded in a precalcined mixed powder of the same composition, subjected to calcining at 1,300° C. for 10 hours by use of an electric furnace.

For pulverized powders of the thus calcined pellets, X-ray diffraction pattern was examined. All the X-ray diffraction patterns resembled the pattern of Ca₂Sn₃O₈. Though not set forth in Table 1, however, in the case where 2−1.5x−0.5y−0.5z<0.5 in Ca_{2-1.5x-0.5y-0.5z}BₓSn_{3-y}M_{y}O₈, an X-ray diffraction peak or peaks due to a foreign crystal or crystals other than Ca₂Sn₃O₈ were observed.

The calcined pellets were served to measurement of lithium ion conductivity at room temperature by an AC impedance method, the results being set forth in Table 1. The calcined pellets were found to have an ionic conductivity of the order of magnitude of 10⁻⁵.

Furthermore, resistance to reduction of each solid electrolyte was evaluated by measuring the potential at which a reduction current is generated, by the same method as in Example 1. For each solid electrolyte, it was found that at least the reduction potential is less than 1 V. Thus, each solid electrolyte was confirmed to be excellent in resistance to reduction.

### EXAMPLE 5

By applying a lithium ion conductive solid electrolyte prepared in Example 1, an all-solid battery was fabricated by the following process, and was evaluated as to charge-discharge characteristics.

### <Preparation of Vanadium Oxide Glasses>

Two kinds of ion-conductive vanadium oxide glasses differing in softening point were prepared. As raw materials, there were used vanadium pentoxide (V₂O₅), phosphorus pentoxide (P₂O₅), tellurium dioxide (TeO₂), and ferric oxide (Fe₂O₃). The raw material composition for a glass A having a higher softening point, in terms of the molar ratio of raw materials, was V₂O₅:P₂O₅:TeO₂:Fe₂O₃=47:13:30:10. The raw material composition for a glass B having a lower softening point, in molar ratio, was V₂O₅:P₂O₅:TeO₂:Fe₂O₃=55:14:22:9. The raw material powders were placed in platinum crucibles, and were heated by keeping at 1,100° C. for 1 hour by use of an electric furnace. Incidentally, during the heating the raw materials in each of the platinum crucibles were stirred to be uniform. Thereafter, the platinum crucibles were taken out of the electric furnace, and the melts in the crucibles were let flow onto a stainless steel plate preliminarily heated at 150° C., followed by natural cooling, to obtain vanadium oxide glasses. The softening points of the glass A and the glass B measured by differential thermal analysis were 356° C. and 345° C., respectively. Besides, the thus prepared glasses were mechanically pulverized to an average particle diameter of about 3 μm.

### <Positive Electrode>

A LiCoO₂ powder having an average particle diameter of 5 μm as a positive electrode active material, the powder of the glass A prepared above, a Li_{3.6}Sn_{2.6}Nb_{0.4}O₈ powder (hereinafter described as LSNO) having an average particle diameter of 3 μm which is the solid electrolyte (No. 7 in Table 1) produced in Example 1, and conductive titanium oxide (having rutile type titanium oxide as a base material coated with a Sb-doped SnO₂ conductive layer) in an acicular form (minor axis: 0.13 μm, major axis: 1.68 μm) as a conductive assistant were mixed in a volume ratio of 53:30:10:7, and appropriate amounts of a resin binder and a solvent were added to the mixed powder, to prepare a positive electrode paste. Note that ethyl cellulose and nitrocellulose were used as the resin binder, and butylcarbitol acetate was used as the solvent. The positive electrode paste was applied to a 20 μm-thick aluminum foil. After a heat treatment for removing the solvent and the binder, the resulting coating was calcined at 360° C. in atmospheric air for 15 minutes, to obtain a positive electrode sheet with a positive electrode active material layer having a thickness of 10 μm. The positive electrode sheet was die-cut into a disk having a diameter of 14 mm, which was made to be a positive electrode.

### <Negative Electrode>

A Li₄Ti₅O₁₂ powder having an average particle diameter of 5 μm as a negative electrode active material, the power of the glass A prepared above, LSNO having an average particle diameter of 3 μm as a solid electrolyte, and conductive titanium oxide (having rutile type titanium oxide as a base material coated with a Sb-doped SnO₂ conductive layer) in an acicular form (minor axis: 0.13 μm, major axis: 1.68 μm) were mixed in a volume ratio of 53:30:10:7, and appropriate amounts of a resin binder and a solvent were added to the mixed powder, to prepare a negative electrode paste. The negative electrode paste was applied to a 20 μm-thick aluminum foil. After a heat treatment for removing the solvent and the binder, the resulting coating was calcined at 360° C. in atmospheric air for 15 minutes, to obtain a negative electrode sheet with a negative electrode active material layer having a thickness of 10 μm. The negative electrode sheet was die-cut into a disk having a diameter of 14 mm, which was made to be a negative electrode.

Note that while the vanadium oxide glass used to form the positive electrode active material layer and the vanadium oxide glass used to form the negative electrode active material layer were the same in this Example, both of the glasses may not necessarily be of the same composition so long as they are ion-conductive vanadium oxide glasses.

### <Solid Electrolyte Layer>

LSNO having an average particle diameter of 3 μm as a solid electrolyte and the powder of the glass B prepared above were mixed in a volume ratio of 70:30, and appropriate amounts of a resin binder and a solvent were added to the mixed powder, to prepare a solid electrolyte paste. The solid electrolyte paste was applied to either the electrode layer of the positive electrode or the electrode layer of the negative electrode. Then, after a heat treatment for removing the solvent and the binder, the resulting coating was calcined in atmospheric air at 350° C., which is a temperature higher than the softening point of the glass B and lower than the softening point of the glass A, for 15 minutes, to obtain a solid electrolyte layer having a thickness of 15μm. The resulting member was die-cut into a disk having a diameter of 15 mm.

While a layer obtained by binding the solid electrolyte particles with a glass was used as the solid electrolyte layer here, this configuration is not restrictive, and a plate-shaped solid electrolyte bulk can also be used.

### <Fabrication of Battery>

The electrode layer with the solid electrolyte layer formed thereon as aforementioned and the other electrode layer were laminated on each other. In order to enhance adhesion at the interfaces between a positive electrode active material layer, a solid electrolyte layer, and a negative electrode active material layer, the laminate was calcined in atmospheric air at 350° C., which is a temperature higher than the softening point of the glass B and lower than the softening point of the glass A, while applying a pressure thereto, for 15 minutes, to effect sufficient adhesion at the interfaces between the layers. A side surface of the laminate thus obtained was masked with an insulator, and the masked laminate was assembled into a CR2025 type coin cell battery, to fabricate an all-solid state battery.

Incidentally, in place of the aforementioned method of forming each of the layers by applying a paste of a mixed powder and calcining the paste, there can be applied a cold spray (CS) process in which a mixed powder is, without being melted or gasified, made to collide against a substrate together with an inert gas in an supersonic stream while remaining in a solid phase, to form a coating film on the substrate. There can also be applied an aerosol deposition (AD) method in which an aerosol formed by mixing a mixed powder with a gas is jetted through a nozzle onto a substrate, while utilizing a gas flow generated by a pressure difference, to form a coating film on the substrate.

A battery fabricating method by the CS process will be described below. A mixed powder of the same LiCoO₂ powder as aforementioned, the glass A powder, the LSNO powder, and the conductive titanium oxide was jetted onto a 20 μm-thick aluminum foil, to form a positive electrode active material layer having a thickness of 10 μm. Note that the powders may be charged respectively in separate feeders and be jetted simultaneously.

A mixed powder of the same LSNO powder as aforementioned and the glass A powder or the glass B powder prepared above was jetted onto the positive electrode active material layer, to form a solid electrolyte layer having a thickness of 15 μm.

Next, a mixed powder of the same Li₄Ti₅O₁₂ powder as aforementioned, the glass A powder, the LSNO powder, and the conductive titanium oxide was jetted onto the solid electrolyte layer, to form a negative electrode active material layer having a thickness of 10 μm.

Furthermore, an aluminum powder is jetted onto the negative electrode active material layer, to form a negative electrode collector layer having a thickness of 20 μm.

### <Evaluation of Battery Characteristics>

For the battery fabricated in Example 5, discharge capacities at rates of 0.1 C and 1 C were examined. The initial discharge capacities at 0.1 C and at 1 C were 140 mAh/g and 110 mAh/g, respectively. Note that similar charge-discharge characteristics were confirmed also for the all-solid state batteries fabricated by applying other ion conductive solid electrolytes than the lithium ion conductive electrolyte.

TABLE 1

| | Raw material | | | | Raw material | | | | | Raw material | | Raw material | | Ionic conductivity |
|---|---|---|---|---|---|---|---|---|---|---|---|---|---|---|
| | of A element | | | | of B element | | | | | of M element | | of N element | | regarding A element |
| No. | Li₂CO₃ | Na₂CO₃ | MgO | CaO | MgO | CaO | SC₂O₃ | Bi₂O₃ | SnO₂ | Nb₂O₅ | Ta₂O₅ | LiF | NaCl | (S/cm) |
| 1 | 2 | — | — | — | — | — | — | — | 3 | — | — | — | — | 3 × 10⁻⁶ |
| 2 | 1.95 | — | — | — | 0.1 | — | — | — | 3 | — | — | — | — | 2 × 10⁻⁵ |
| 3 | 1.9 | — | — | — | 0.2 | — | — | — | 3 | — | — | — | — | 1 × 10⁻⁴ |
| 4 | 1.8 | — | — | — | 0.4 | — | — | — | 3 | — | — | — | — | 5 × 10⁻³ |
| 5 | 1.95 | — | — | — | — | — | — | — | 2.9 | 0.05 | — | — | — | 3 × 10⁻⁵ |
| 6 | 1.9 | — | — | — | — | — | — | — | 2.8 | 0.1 | — | — | — | 2 × 10⁻⁴ |
| 7 | 1.8 | — | — | — | — | — | — | — | 2.6 | 0.2 | — | — | — | 6 × 10⁻³ |
| 8 | 1.9 | — | — | — | — | — | — | — | — | — | — | 0.1 | — | 1 × 10⁻⁵ |
| 9 | 1.8 | — | — | — | — | — | — | — | — | — | — | 0.2 | — | 9 × 10⁻⁵ |
| 10 | 1.6 | — | — | — | — | — | — | — | — | — | — | 0.4 | — | 3 × 10⁻³ |
| 11 | 1.75 | — | — | — | — | 0.1 | — | — | 2.8 | — | 0.1 | 0.1 | — | 2 × 10⁻³ |
| 12 | — | 2 | — | — | — | — | — | — | 3 | — | — | — | — | 1 × 10⁻⁶ |
| 13 | — | 1.95 | — | — | 0.1 | — | — | — | 3 | — | — | — | — | 3 × 10⁻⁵ |
| 14 | — | 1.9 | — | — | 0.2 | — | — | — | 3 | — | — | — | — | 2 × 10⁻⁴ |
| 15 | — | 1.8 | — | — | 0.4 | — | — | — | 3 | — | — | — | — | 4 × 10⁻³ |
| 16 | — | 1.95 | — | — | — | — | — | — | 2.9 | 0.05 | — | — | — | 2 × 10⁻⁵ |
| 17 | — | 1.9 | — | — | — | — | — | — | 2.8 | 0.1 | — | — | — | 3 × 10⁻⁴ |
| 18 | — | 1.8 | — | — | — | — | — | — | 2.6 | 0.2 | — | — | — | 7 × 10⁻³ |
| 19 | — | 1.9 | — | — | — | — | — | — | — | — | — | — | 0.1 | 2 × 10⁻⁵ |
| 20 | — | 1.8 | — | — | — | — | — | — | — | — | — | — | 0.2 | 8 × 10⁻⁵ |
| 21 | — | 1.6 | — | — | — | — | — | — | — | — | — | — | 0.4 | 2 × 10⁻³ |
| 22 | — | 1.75 | — | — | — | 0.1 | — | — | 2.8 | — | 0.1 | — | 0.1 | 1 × 10⁻³ |
| 23 | — | 1.8 | — | — | — | — | — | — | 2.6 | 0.2 | — | — | — | 5 × 10⁻³ |
| | | | | | | | | | | | | | | (Li ion conductivity) |
| 24 | — | — | 3.8 | — | — | — | 0.1 | — | 3 | — | — | — | — | 7 × 10⁻⁵ |
| 25 | — | — | 3.8 | — | — | — | — | — | 2.8 | 0.1 | — | — | — | 5 × 10⁻⁶ |
| 26 | — | — | — | 3.8 | — | — | — | 0.1 | 3 | — | — | — | — | 5 × 10⁻⁵ |
| 27 | — | — | — | 3.8 | — | — | — | — | 2.8 | — | 0.1 | — | — | 3 × 10⁻⁵ |
| 28 | — | 0.5 | — | — | 1 | — | — | — | 2 | — | 0.5 | — | — | 8 × 10⁻³ |
| 29 | — | 1 | 0.5 | — | — | — | — | — | 2 | — | 0.5 | — | — | 7.5 × 10⁻³ |

### DESCRIPTION OF REFERENCE NUMERALS

201: Positive electrode collector
202: Positive electrode active material particles
203: Vanadium oxide glass
204: Solid electrolyte particles
205: Negative electrode active material particles
206: Negative electrode collector
207: Positive electrode active material layer
208: Solid electrolyte layer
209: Negative electrode active material layer

1. A solid electrolyte comprising a crystal having a structure expressed as A_{4-2x-y-z}BₓSn_{3-y}M_{y}O_{8-z}N_{z} (1≦4−2x−y−z<4, A: Li, Na, B: Mg, Ca, Sr, Ba, M: V, Nb, Ta, N: F, Cl).

2. A solid electrolyte comprising a crystal having a structure expressed as A_{2-1.5x-0.5y-0.5z}BₓSn_{3-y}M_{y}O_{8-z}N_{z} (0.5≦2−1.5x−0.5y−0.5z<2, A: Mg, Ca, B: Sc, Y, Sb, Bi, M: V, Nb, Ta, N: F, Cl).

3. A solid electrolyte wherein particles comprising the solid electrolyte according to claim 1 are bound together by a vanadium oxide glass.

4. A solid electrolyte wherein particles comprising the solid electrolyte according to claim 2 are bound together by a vanadium oxide glass.

5. An all-solid state ion secondary battery wherein a solid electrolyte layer comprising the solid electrolyte according to claim 1 is joined between a positive electrode active material layer and a negative electrode active material layer.

6. An all-solid state ion secondary battery wherein a solid electrolyte layer comprising the solid electrolyte according to claim 2 is joined between a positive electrode active material layer and a negative electrode active material layer.

7. An all-solid state ion secondary battery wherein a solid electrolyte layer comprising the solid electrolyte according to claim 3 is joined between a positive electrode active material layer and a negative electrode active material layer.

8. An all-solid state ion secondary battery wherein a solid electrolyte layer comprising the solid electrolyte according to claim 4 is joined between a positive electrode active material layer and a negative electrode active material layer.
